(19) United States
(12) Patent Application Publication
(10) Pub. No.: US 2026/0208110 A1
(43) Pub. Date: Jul. 23, 2026

(54) NEGATIVE PRESSURE REVERSE OSMOSIS FILTERING DEVICE AND FILTERING SYSTEM HAVING THE SAME

(71) Applicant: EVERINN INTERNATIONAL CO., LTD., Taichung City (TW)

(72) Inventor: Tsung-Hsin Wu, Taichung City (TW)

(73) Assignee: EVERINN INTERNATIONAL CO., LTD., Taichung City (TW)

(21) Appl. No.: 19/289,406

(22) Filed: Aug. 4, 2025

(30) Foreign Application Priority Data
Jan. 17, 2025 (TW) 114102160

(51) Int. Cl. B01D 61/08; B01D 61/02; C02F 1/44

(52) U.S. Cl. CPC B01D 61/08; B01D 61/025; C02F 1/441; B01D 2313/02; B01D 2313/21; B01D 2313/221

(57) ABSTRACT

A negative pressure reverse osmosis filtering device includes a barrel member, a linking cap having two cap openings, an end cap unit including an end cap, and a reverse osmosis filtering member cooperatively defining a chamber space with the barrel member, and having an inner space. One of the cap openings and the chamber space cooperatively define a first flow channel. The inner space and another one of the cap openings cooperatively define a second flow channel. One of the first flow channel and the second flow channel is in a negative pressure state, such that a fluid in another one of the first flow channel and the second flow channel is drawn to flow through the reverse osmosis filtering member into the one of the first flow channel and the second flow channel, and eventually flows out of the negative pressure reverse osmosis filtering device.

### CROSS-REFERENCE TO RELATED APPLICATION

This application claims priority to Taiwanese Invention Patent Application No. 114102160, filed on January 17, 2025, the entire disclosure of which is incorporated by reference herein.

### FIELD

The disclosure relates to a filtering device, and more particularly to a negative pressure reverse osmosis filtering device and a filtering system that has the negative pressure reverse osmosis filtering device.

### BACKGROUND

Referring to FIG. 1, a conventional filtering device 1 includes a barrel member 11 that has a top end and a bottom end 112 along an axis (X), a top end cap 12 and a bottom end cap 13 that are respectively disposed on the top end and the bottom end 112, and an impeller 14 that is disposed between the barrel member 11 and the top end cap 12. The barrel member 11 defines a vortex chamber 110. The top end cap 12 has an air inlet 121 and an air outlet 122 that are opposite to each other and that spatially communicate with the vortex chamber 110.

A filtering process of the conventional filtering device 1 is as follows. After a mixture of foreign substances (e.g., oil mist, water mist, smoke, dust, or exhaust) and air enters the air inlet 121, the mixture passes through the impeller 14 to enter the vortex chamber 110. The impeller 14 pushes the mixture such that the mixture forms a vortex as shown by the hollow arrow in FIG. 1. The foreign substances in the mixture are moved by a centrifugal force of the vortex away from the axis (X) and towards an inner surface of the barrel member 11. After the foreign substances come into contact with the inner surface of the barrel member 11, the foreign substances fall downwardly and are gathered at the bottom end cap 13. Finally, the filtered mixture flows through the air outlet 122 to exit the conventional filtering device 1.

However, since the foreign substances are removed from the mixture through the centrifugal force, the filtering process is only effective in filtering foreign substances with sufficient volume or weight; that is to say, foreign substances with smaller volume or lighter weight may still remain in the mixture after the filtering process, which may cause damage to components (e.g., a blower) that are connected to the conventional filtering device 1 and through which the mixture flows. Hence, how to filter small and light foreign substances to increase cleanliness of fluids is a problem many manufacturers wish to solve.

### SUMMARY

Therefore, an object of the disclosure is to provide a negative pressure reverse osmosis filtering device that can alleviate at least one of the drawbacks of the prior art.

According to the disclosure, the negative pressure reverse osmosis filtering device includes a barrel member, a linking cap, an end cap unit, and a reverse osmosis filtering member. The barrel member has two opposite end portions along an axis. The linking cap is connected removably to one of the end portions, and has two cap openings for inlet and outlet of a fluid, respectively. The end cap unit includes an end cap that is connected removably to another one of the end portions and that has an inner frustoconical surface. The reverse osmosis filtering member is disposed in the barrel member, extends along the axis, and abuts against the linking cap and the end cap unit. The reverse osmosis filtering member surrounds the axis, has an inner space that extends along the axis (L), and has an outer frustoconical surface that abuts against the inner frustoconical surface. The reverse osmosis filtering member and the barrel member cooperatively define a chamber space therebetween. One of the cap openings and the chamber space cooperatively define a first flow channel. The inner space of the reverse osmosis filtering member and another one of the cap openings cooperatively define a second flow channel. One of the first flow channel and the second flow channel is in a negative pressure state, such that a fluid in another one of the first flow channel and the second flow channel is drawn to flow through the reverse osmosis filtering member into the one of the first flow channel and the second flow channel, and eventually flows out of the negative pressure reverse osmosis filtering device.

Another object of the disclosure is to provide a filtering system that includes the above-mentioned negative pressure reverse osmosis filtering device, a heat exchange device for regulating a temperature of a fluid flowing therethrough, a link device removably interconnecting the negative pressure reverse osmosis filtering device and the heat exchange device, and a drive device connected to the link device for driving the fluid to flow through the negative pressure reverse osmosis filtering device and the heat exchange device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view of a conventional filtering device.

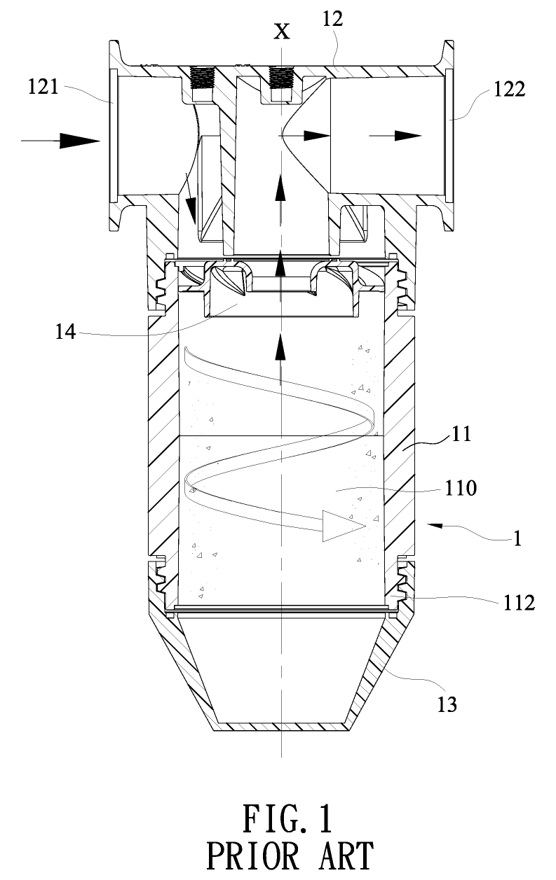

FIG. 2 is a perspective view illustrating an embodiment of a negative pressure reverse osmosis filtering device according to the disclosure.

FIG. 3 is an exploded perspective view of the embodiment.

FIG. 4 is a sectional view of the embodiment.

FIG. 5 is a sectional view illustrating three negative pressure reverse osmosis filtering devices being connected to a link device.

FIG. 6 is a fragmentary sectional view of the embodiment being connected to a filter module.

FIG. 7 is a fragmentary perspective view illustrating an embodiment of a filtering system according to the disclosure.

FIG. 8 is a sectional view of a heat exchange device of the filtering system.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

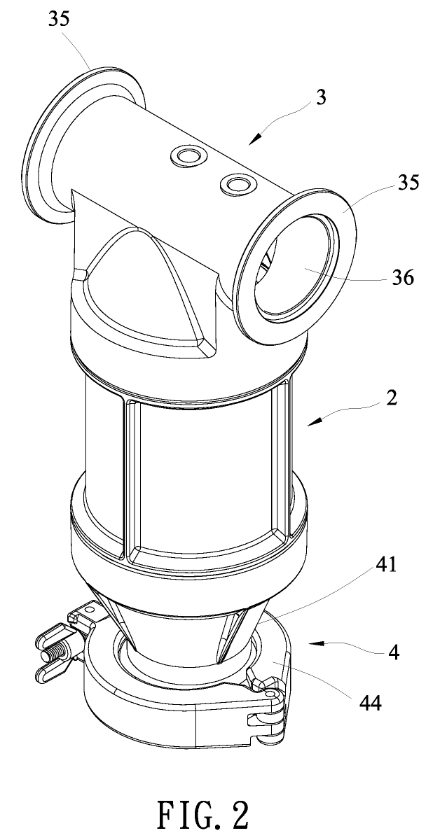

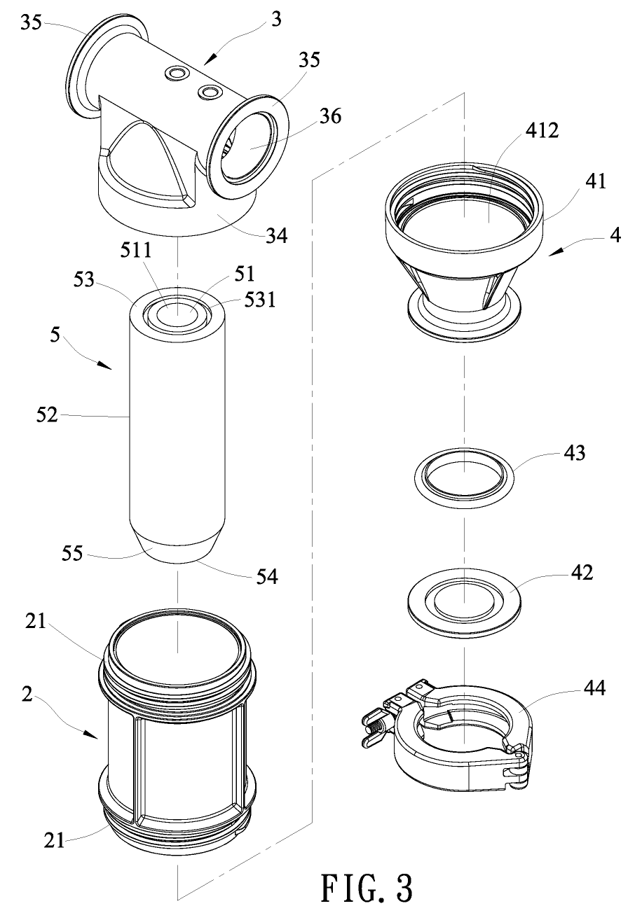

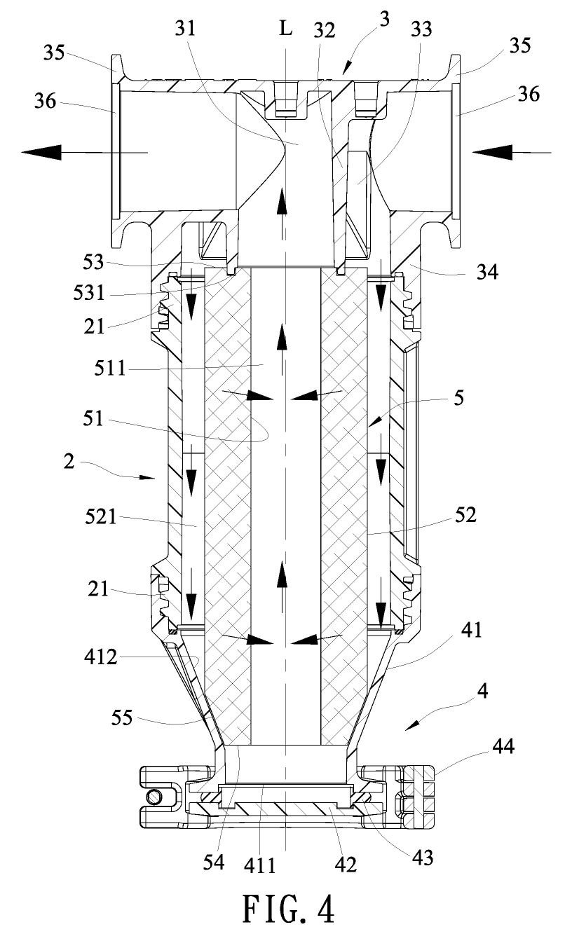

Referring to FIGS. 2 to 4, an embodiment of a negative pressure reverse osmosis filtering device according to the disclosure includes a barrel member 2, a linking cap 3, an end cap unit 4, and a reverse osmosis filtering member 5.

The barrel member 2 has two opposite end portions 21 along an axis (L).

The linking cap 3 is connected removably to one of the end portions 21, and has a tubular portion 32 that surrounds the axis (L) and that defines a tubular space 31 therein, and a main portion 34 that surrounds the tubular portion 32 and that cooperates with the tubular portion 32 to define a curved space 33 therebetween. The main portion 34 has two cap openings 36 for inlet and outlet of a fluid, respectively. Specifically, the main portion 34 has two flange ends 35 that are opposite to each other. Each of the flange ends 35 defines a respective one of the cap openings 36. One of the can openings 36 spatially communicates with the curved space 33, and another one of the can openings 36 spatially communicates with the tubular space 31. The tubular space 31 and the curved space 33 are isolated from each other.

The end cap unit 4 includes an end cap 41 that is connected removably to another one of the end portions 21, a cover member 42 that is spaced apart from the end cap 41 along the axis (L), a waterproof member 43 that is clamped between the end cap 41 and the cover member 42, and a securing member 44 that is connected removably to the end cap 41 and the cover member 42. The end cap 41 has an end opening 411 that is located on the axis (L), and an inner frustoconical surface 412. The securing member 44 is for securing the cover member 42 to the end cap 41 and closing the end opening 411. In this embodiment, the securing member 44 is configured as a quick-release clamp. The securing member 44 has a screw extending through two ends thereof. By turning the screw to drive the two ends of the securing member 44 to move towards each other, the end cap 41 and the cover member 42 are tightly connected to each other.

The reverse osmosis filtering member 5 is disposed in the barrel member 2, extends along and surrounds the axis (L), and abuts against the linking cap 3 and the end cap unit 4. Specifically, the reverse osmosis filtering member 5 has an inner tubular surface 51 that surrounds the axis (L), an outer tubular surface 52 that surrounds the inner tubular surface 51 and that is opposite to the inner tubular surface 51, a first ring surface 53 and a second ring surface 54 that are opposite to each other along the axis (L), and an outer frustoconical surface 55 that abuts against the inner frustoconical surface 412. The inner tubular surface 51 defines an inner space 511 that extends along the axis (L). The first ring surface 53 interconnects the inner tubular surface 51 and the outer tubular surface 52 and is connected to the linking cap 3. The second ring surface 54 is directly connected to the inner tubular surface 51. The outer frustoconical surface 55 is connected between the outer tubular surface 52 and the second ring surface 54. The reverse osmosis filtering member 5 further has an engaging groove 531 that is formed in the first ring surface 53 and that is engaged with the tubular portion 32 of the linking cap 3.

The reverse osmosis filtering member 5 and the barrel member 2 cooperatively define a chamber space 521 therebetween. Specifically, the outer tubular surface 52 and the barrel member 2 cooperatively define the chamber space 521. The one of the cap openings 36, the curved space 33, and the chamber space 521 cooperatively define a first flow channel adapted for passage of a fluid. The inner space 511 of the reverse osmosis filtering member 5, the tubular space 31, and the another one of the cap openings 36 cooperatively define the second flow channel adapted for passage of a fluid. One of the first flow channel and the second flow channel is in a negative pressure state, such that a fluid in another one of the first flow channel and the second flow channel is drawn to flow through the reverse osmosis filtering member 5 into the one of the first flow channel and the second flow channel, and eventually flows out of the negative pressure reverse osmosis filtering device. In this embodiment, the second flow channel is in the negative pressure state.

In this embodiment, the barrel member 2, the linking cap 3, and the end cap 41 are made of aluminum, but in other embodiments, they may be made of other metals with large heat transfer coefficients, such as copper.

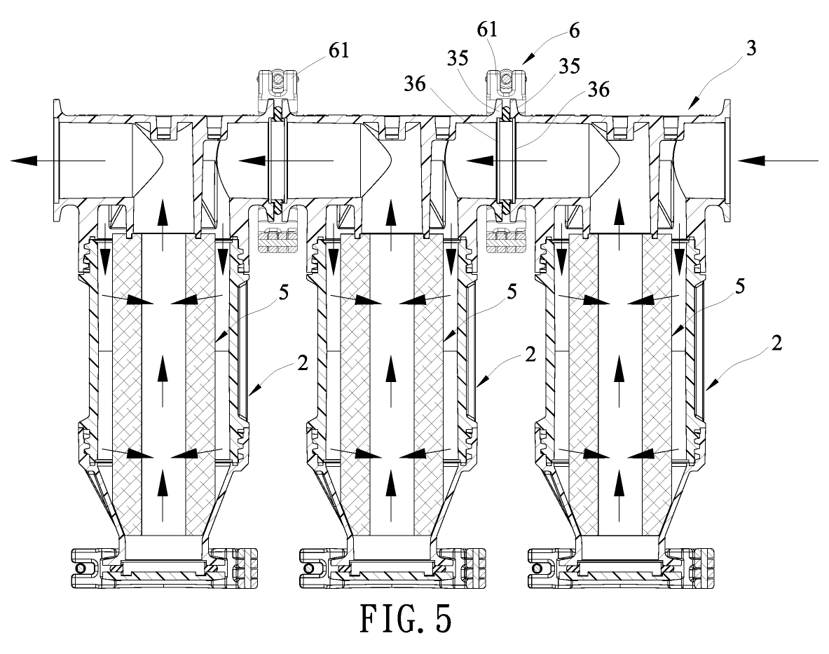

Multiple negative pressure reverse osmosis filtering devices can be connected to each other by a link device 6. For example, in an embodiment as shown in FIG. 5, the link device 6 may include two link members 61 interconnecting three negative pressure reverse osmosis filtering devices. In this embodiment, the negative pressure reverse osmosis filtering devices are connected in series, but in other embodiments, the negative pressure reverse osmosis filtering devices may be connected in parallel. A fluid flows through a first one of the negative pressure reverse osmosis filtering devices, a second one of the negative pressure reverse osmosis filtering devices, and a third one of the negative pressure reverse osmosis filtering devices in sequence. Specifically, for each of the negative pressure reverse osmosis filtering devices, the fluid flows into the first flow channel, is filtered by the reverse osmosis filtering member 5, and then flows into the second flow channel to enter a next one of the negative pressure reverse osmosis filtering devices. Since the fluid is filtered by three reverse osmosis filtering members 5, the cleanliness of the filtered fluid is raised.

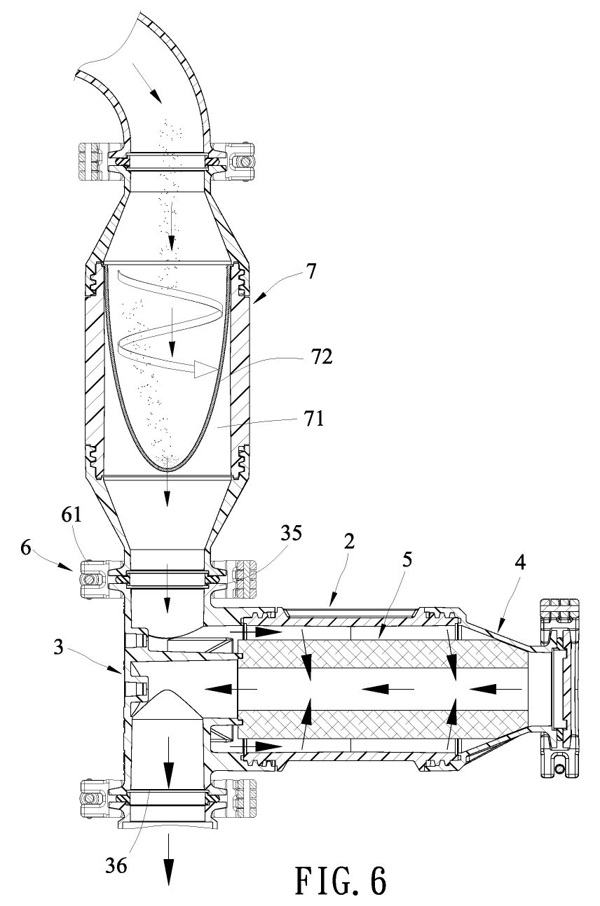

Referring to FIG. 6, in another embodiment, the negative pressure reverse osmosis filtering device is adapted to be connected to a filter module 7 through the link device 6. The filter module 7 may be a cyclone separation filter module as disclosed in Taiwanese Invention Patent No. I589344, or a cyclone filter as disclosed in Taiwanese Invention Patent Application Publication No. 201912230. The filter module 7 includes a passage 71 for passage of a fluid, and a capture member 72 disposed in the passage 71 for blocking foreign substances that are over a certain size. Since the filter module 7 is well known in the art, further description thereof will be omitted for the sake of brevity.

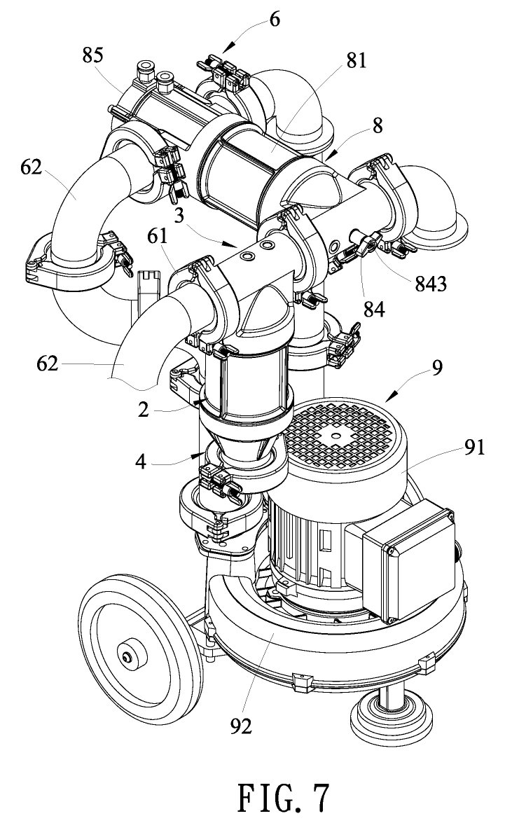

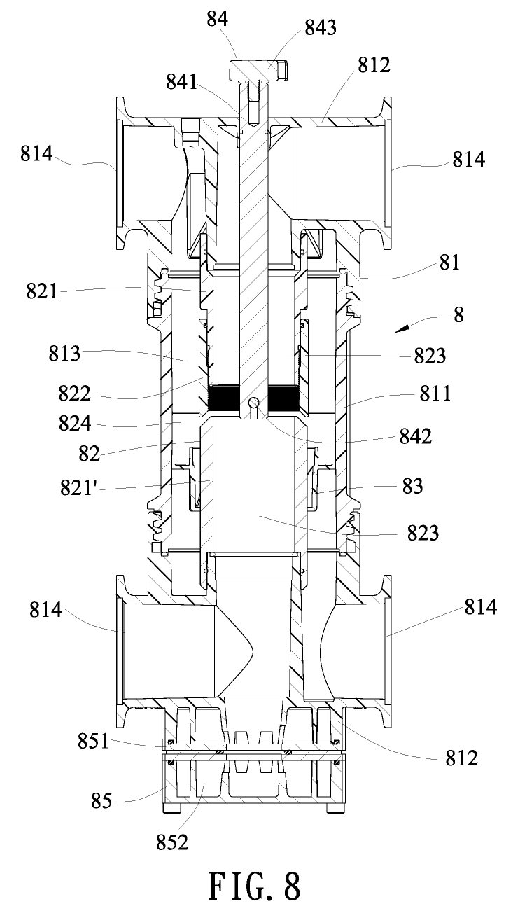

Referring to FIGS. 7 and 8, an embodiment of a filtering system according to the disclosure includes the abovementioned negative pressure reverse osmosis filtering device, a link device 6, a heat exchange device 8, and a drive device 9.

The link device 6 includes a plurality of link members 61 that are removably connected to the negative pressure reverse osmosis filtering device, and a plurality of link tubes 62 that are connected to the link members 61. The link device 6 removably interconnects the negative pressure reverse osmosis filtering devices, the heat exchange device 8, and the drive device 9.

The heat exchange device 8 is for regulating a temperature of a fluid flowing therethrough, and includes a barrel unit 81, a tube unit 82, a ring member 83, a drive unit 84, and a cooling unit 85.

The barrel unit 81 includes an outer barrel 811 and two barrel caps 812 that are connected respectively to opposite ends of the outer barrel 811. The outer barrel 811 and the tube unit 82 cooperatively define a vortex space 813 therebetween. Each of the barrel caps 812 has two open ends 814 that are opposite to each other.

The tube unit 82 is disposed in the outer barrel 811, and includes a first tube member 821 and a second tube member 821’ that are respectively connected to the barrel caps 812, and an adjustment tube member 822 that is disposed between the first tube member 821 and the second tube member 821’, that is connected threadedly to one of the first tube member 821 and the second tube member 821’, and that cooperates with another one of the first tube member 821 and the second tube member 821’ to define a gap 824 therebetween. In this embodiment, the adjustment tube member 822 is connected to the first tube member 821. Each of the first tube member 821 and the second tube member 821’ defines a flow space 823 therein. The flow space 823 of each of the first tube member 821 and the second tube member 821’, one of the open ends 814 of one of the barrel caps 812, and one of the open ends 814 of another one of the barrel caps 812 cooperatively define a third flow channel. The vortex space 813, another one of the open ends 814 of the one of the barrel caps 812, and another one of the open ends 814 of the another one of the barrel caps 812 cooperatively define a fourth flow channel. The gap 824 is in spatial communication with the flow space 823 of each of the first tube member 821 and the second tube member 821’, and the vortex space 813.

The ring member 83 is disposed in the vortex space 813.

The drive unit 84 includes a rotary shaft 841 that extends rotatably through the one of the barrel caps 812, a connecting rod 842 that is perpendicular to the rotary shaft 841 and that is connected to the rotary shaft 841 and the adjustment tube member 822, and an operating member 843 that is disposed outside of the one of the barrel caps 812, that is connected to an end of the rotary shaft 841, and that is operable for driving rotation of the rotary shaft 841 about the axis (L), such that the rotation of the rotary shaft 841 drives the adjustment tube member 822 to rotate relative to the another one of the first tube member 821 and the second tube member 821’, thereby expanding or shrinking the gap 824.

The cooling unit 85 is mounted to the another one of the barrel caps 812 that is opposite to the drive unit 84, and includes a thermoelectric cooling module 851 that is adapted for reducing a temperature of a fluid in the barrel unit 81, and a heat dissipation module 852 that is in contact with the thermoelectric cooling module 851. Specifically, due to the Peltier effect, when the cooling unit 85 is connected to a direct current source, the thermoelectric cooling module 851 reduces the temperature of the fluid in the barrel unit 81, and heat is dissipated through the dissipation module 852.

The drive device 9 is connected to the link device 6 for driving the fluid to flow through the negative pressure reverse osmosis filtering device and the heat exchange device 8. Specifically, the drive device 9 includes a motor 91, and a blower 92 that is connected to the link tubes 62. The motor 91 operates the blower 92 to drive the fluid to flow through the negative pressure reverse osmosis filtering device and the heat exchange device 8.

Compared to the abovementioned conventional filtering device which relies on a centrifugal force to filter foreign substances, the negative pressure reverse osmosis filtering device of the disclosure filters a fluid by drawing the fluid to move through the reverse osmosis filtering member 5. Specifically, the fluid in the first flow channel is drawn to flow through the reverse osmosis filtering member 5 into the second flow channel by virtue of the negative pressure state the second flow channel is in. Advantages of the negative pressure reverse osmosis filtering device of the disclosure is as follows.

1. The reverse osmosis filtering member 5 is porous, and a pore size thereof is smaller than 0.001 micrometers. The reverse osmosis filtering member 5 only allows passage of water molecules and foreign substances that are smaller than water molecules, thereby removing most of the harmful foreign substances, which are bigger than the water molecules, from the fluid flowing through the negative pressure reverse osmosis filtering device, and thus cleanliness of the fluid that has been filtered is increased.

2. A filtering function of the reverse osmosis filtering member 5 can be restored through cleaning and washing, thereby allowing the reverse osmosis filtering member 5 to be re-used. Since the reverse osmosis filtering member 5 does not need to be replaced after being used for a period of time, waste is reduced.

3. Since the outer frustoconical surface 55 abuts against the inner frustoconical surface 412, during an assembly process of the negative pressure reverse osmosis filtering device, the reverse osmosis filtering member 5 is automatically positioned relative to the end cap 41, and the end cap 41 abuts the reverse osmosis filtering member 5 tightly against the linking cap 3. Hence, the negative pressure reverse osmosis filtering device has a simple structure and an assembly process thereof is convenient and simple, which saves costs.

4. The filtering system of the disclosure is modularized and can be used in systems that require cooling and filtering, or in manufacturing systems. The filtering system not only raises the cleanliness of the fluid such that quality of a product is increased when the product is produced by a system that includes the filtering system of the disclosure, but also preserves the lifespan of components which the fluid flows past, since the harmful foreign substances in the fluid are reduced after the fluid is filtered.

Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A negative pressure reverse osmosis filtering device comprising:
a barrel member having two opposite end portions along an axis;
a linking cap connected removably to one of said end portions, and having two cap openings for inlet and outlet of a fluid, respectively;
an end cap unit including an end cap that is connected removably to another one of said end portions and that has an inner frustoconical surface; and
a reverse osmosis filtering member disposed in said barrel member, extending along the axis, and abutting against said linking cap and said end cap unit, said reverse osmosis filtering member surrounding the axis, having an inner space that extends along the axis, and having an outer frustoconical surface that abuts against said inner frustoconical surface, said reverse osmosis filtering member and said barrel member cooperatively defining a chamber space therebetween;
wherein one of said cap openings and said chamber space cooperatively define a first flow channel;
wherein said inner space of said reverse osmosis filtering member and another one of said cap openings cooperatively define a second flow channel; and
wherein one of said first flow channel and said second flow channel is in a negative pressure state, such that a fluid in another one of said first flow channel and said second flow channel is drawn to flow through said reverse osmosis filtering member into said one of said first flow channel and said second flow channel, and eventually flows out of said negative pressure reverse osmosis filtering device.

2. The negative pressure reverse osmosis filtering device as claimed in claim 1, wherein:
said linking cap has a tubular portion that surrounds the axis and that defines a tubular space therein, and a main portion that surrounds said tubular portion and that cooperates with said tubular portion to define a curved space therebetween;
said main portion has two flange ends that are opposite to each other, each of said flange ends defining a respective one of said cap openings;
said one of said cap openings, said curved space, and said chamber space cooperatively define said first flow channel; and
said inner space of said reverse osmosis filtering member, said tubular space, and said another one of said cap openings cooperatively define said second flow channel.

3. The negative pressure reverse osmosis filtering device as claimed in claim 1, wherein:
said end cap further has an end opening that is located on the axis; and
said end cap unit further includes
a cover member that is spaced apart from said end cap along the axis,
a waterproof member that is clamped between said end cap and said cover member, and
a securing member that is connected removably to said end cap and said cover member for securing said cover member to said end cap and closing said end opening.

4. The negative pressure reverse osmosis filtering device as claimed in claim 3, wherein said securing member is configured as a quick-release clamp.

5. The negative pressure reverse osmosis filtering device as claimed in claim 1, wherein said reverse osmosis filtering member has:
an inner tubular surface that surrounds the axis and that defines said inner space;
an outer tubular surface that surrounds said inner tubular surface and that is opposite to said inner tubular surface;
a first ring surface that interconnects said inner tubular surface and said outer tubular surface and that is connected to said linking cap; and
a second ring surface that is opposite to said first ring surface along the axis and that is directly connected to said inner tubular surface, said outer frustoconical surface being connected between said outer tubular surface and said second ring surface.

6. The negative pressure reverse osmosis filtering device as claimed in claim 5, wherein said reverse osmosis filtering member further has an engaging groove that is formed in said first ring surface and that is engaged with said tubular portion of said linking cap.

7. The negative pressure reverse osmosis filtering device as claimed in claim 5, wherein each of said barrel member, said linking cap, and said end cap is made of metal.

8. A filtering system comprising:
said negative pressure reverse osmosis filtering device as claimed in claim 1;
a heat exchange device for regulating a temperature of a fluid flowing therethrough;
a link device removably interconnecting said negative pressure reverse osmosis filtering device and said heat exchange device; and
a drive device connected to said link device for driving the fluid to flow through said negative pressure reverse osmosis filtering device and said heat exchange device.

9. The filtering system as claimed in claim 8, wherein:
said heat exchange device includes
a barrel unit including an outer barrel and two barrel caps that are connected respectively to opposite ends of said outer barrel, each of said barrel caps having two open ends that are opposite to each other,
a tube unit disposed in said barrel unit, and including a first tube member and a second tube member that are respectively connected to said barrel caps, and an adjustment tube member that is disposed between said first tube member and said second tube member, that is connected threadedly to one of said first tube member and said second tube member, and that cooperates with another one of said first tube member and said second tube member to define a gap therebetween, each of said first tube member and said second tube member defining a flow space therein, said outer barrel of said barrel unit and said tube unit cooperatively defining a vortex space therebetween, said gap being in spatial communication with said flow space of each of said first tube member and said second tube member and said vortex space of said heat exchange device, and
a drive unit including a rotary shaft that extends rotatably through one of said barrel caps, and a connecting rod that is perpendicular to said rotary shaft and that is connected to said rotary shaft and said adjustment tube member such that rotation of said rotary shaft drives said adjustment tube member to rotate relative to said another one of said first tube member and said second tube member, thereby expanding or shrinking said gap;
said flow space of each of said first tube member and said second tube member, one of said open ends of one of said barrel caps, and one of said open ends of another one of said barrel caps cooperatively define a third flow channel; and
said vortex space of said heat exchange device, another one of said open ends of said one of said barrel caps, and another one of said open ends of said another one of said barrel caps cooperatively define a fourth flow channel.

10. The filtering system as claimed in claim 9, wherein said heat exchange device further includes a cooling unit that is mounted to one of said barrel caps opposite to said drive unit, said cooling unit including a thermoelectric cooling module that is adapted for reducing a temperature of a fluid in said barrel unit, and a heat dissipation module that is in contact with said thermoelectric cooling module.
